(19) United States
(12) Patent Application Publication
(10) Pub. No.: US 2018/0074940 A1
(43) Pub. Date: Mar. 15, 2018

(54) DEBUG SYSTEM, MICROCOMPUTER, AND ITS METHOD

(71) Applicant: RENESAS ELECTRONICS CORPORATION, Tokyo (JP)

(72) Inventors: Mamoru YAMAMOTO, Tokyo (JP); Shinsuke FUKUSHIMA, Tokyo (JP)

(21) Appl. No.: 15/701,047

(22) Filed: Sep. 11, 2017

(30) Foreign Application Priority Data
Sep. 14, 2016 (JP) 2016-179302

(51) Int. Cl. G06F 11/36

(52) U.S. Cl. CPC G06F 11/3656; G06F 11/3652

(57) ABSTRACT

A microcomputer includes a CPU core, a memory which stores a program to be debugged and a debugging program, an event detection unit which detects establishment of an event, a debug interruption generation unit which transits a program to the debugging program when the event is established, and a debug interface control unit. The CPU core executes the debugging program, thereby informing an emulator of an event number of the established event through the debug interface control unit, and right thereafter restarting execution of the program to be debugged.

### CROSS-REFERENCE TO RELATED APPLICATIONS

The disclosure of Japanese Patent Application No. 2016-179302 filed on Sep. 14, 2016 including the specification, drawings and abstract is incorporated herein by reference in its entirety.

The present invention relates to a debug system, a microcomputer, and its method, and relates, for example, to a debug system which performs debugging using an on-chip debug system, its microcomputer, and its method.

### BACKGROUND

In recent years, microcomputers having an on-chip debug function with a program debugging function are increasing. The debug system using the on-chip debug function is called an on-chip debug system. The debug system with the on-chip debug system includes a host machine, a microcomputer to be debugged, and an emulator which relays between the host machine and the microcomputer to be debugged. The emulator communicates with the microcomputer to be debugged, thereby extracting an execution state of the program to be debugged inside the microcomputer in the host machine and rewriting the program to be debugged from the host machine.

Descriptions will now be made to an event detection function in the debug system with the on-chip debug system. The event detection function is provided for an event detector inside a debug circuit to detect that a CPU (Central Processing Unit) core executes a specified address in accordance with a program to be debugged, and for a debug interruption generation unit inside the debug circuit to generate a debug interruption. By this debug interruption, control by the CPU core is transited from the program to be debugged to a monitor program for debugging. This causes to stop the program to be debugged. After this, the monitor program is executed. Then, the CPU core informs the emulator of stop of the program to be debugged through a debug interface. Then, the CPU core is in a standby state of receiving a debug control request command from the emulator.

The emulator detects stop of the program to be debugged through the debug interface, and informs a debugger GUI (Graphical User Interface) operating on the host machine of the stop of the program to be debugged through the host interface.

Upon reception of information representing the stop of the program to be debugged, the debugger GUI confirms establishment of an event by reading the state of the microcomputer to be debugged. The debugger GUI transmits a dedicated debug control request command to the microcomputer to be debugged through the emulator, when to restart execution of the program to be debugged. The microcomputer which has received the debug control request command returns from the debug interruption, thereby restarting the execution of the program to be debugged.

In the above-described event detection function, it is necessary to stop the program to be debugged, for the host machine to acquire the establishment of an event. It takes a long time since the stop of the program to be debugged until restart of execution, that is, it takes several msec. This is because communication through the debug interface and the host interface occurs a plurality of times, since the stop of the program to be debugged until the restart of execution.

Japanese Unexamined Patent Application Publications Nos. 2012-133752 and 2006-293560 disclose an example of shortening the stop time of the program to be debugged in the event detection function or an example of not stopping the program to be debugged, in the debug system with the on-chip debug system.

Japanese Unexamined Patent Application Publication No. 2012-133752 discloses a technique for measuring the time between two events generated in a program execution period of the CPU, in the microcomputer. In the technique disclosed in Japanese Unexamined Patent Application Publication No. 2012-133752, the microcomputer does not externally inform stop of the program to be debugged, thus enabling to shorten the time for stopping the program to be debugged.

Japanese Unexamined Patent Application Publication No. 2006-293560 discloses a technique, at the generation of writing to a specified address into a memory in an MCU (Micro Control Unit), for transferring its address value or generation time data to a transmission buffer memory, using DMA (Direct Memory Access) transfer and transmitting it to a reception memory of a debugger. In the technique disclosed in Japanese Unexamined Patent Application Publication No. 2006-293560, it is controlled not to stop execution of the program to be debugged, by using the DMA transfer.

### SUMMARY

However, in the technique disclosed in Japanese Unexamined Patent Application Publication No. 2012-133752, a debug circuit in the microcomputer needs an event function unit and a time measurement function unit, thus resulting in a problem of increasing the chip area. The technique disclosed in Japanese Unexamined Patent Application Publication No. 2012-133752 has a problem that a timer in the microcomputer is occupied for measuring the time between events.

In the technique disclosed in Japanese Unexamined Patent Application Publication No. 2006-293560, a DMA controller for performing the DMA transfer is necessary in the microcomputer, resulting in a problem of increasing the chip area. Even if the microcomputer includes a DMA controller in advance, there is still a problem that the DMA controller is occupied for transferring the address value or the generation time data.

Other objects and new features will be apparent from the descriptions of the present specification and the accompanying drawings.

According to an embodiment, in a microcomputer, the CPU core executes a program for debugging. By so doing, it informs an emulator of an event number of an established event through a debug interface control unit, and immediately restarts execution of the program to be debugged.

According to the embodiment, it is possible to provide the microcomputer which can shorten the stop time of the program to be debugged in the event detection function, without increasing the chip area and occupying the resource in the microcomputer.

### BRIEF DESCRIPTION OF THE DRAWINGS

FIG. 1 is a block diagram illustrating a configuration example of a debug system according to an embodiment 1.

FIG. 2 is a block diagram illustrating a configuration example of a microcomputer to be debugged, according to the embodiment 1.

FIG. 3 is a diagram illustrating an example of a debugging program, according to the embodiment 1.

FIG. 4 is a flow diagram illustrating an operational example of a microcomputer to be debugged, according to the embodiment 1.

FIG. 5 is a block diagram illustrating a configuration example of an emulator, according to the embodiment 1.

FIG. 6 is a block diagram illustrating a configuration example of a host machine, according to the embodiment 1.

FIG. 7 is a block diagram illustrating a configuration example of a microcomputer to be debugged, according to an embodiment 2.

FIG. 8 is a diagram illustrating an example of a debugging program, according to the embodiment 2.

FIG. 9 is a flow diagram illustrating an operational example of the microcomputer to be debugged, according to the embodiment 2.

FIG. 10 is a diagram illustrating an example of an event in a program to be debugged, according to the embodiment 2.

FIG. 11 is a diagram illustrating an example of a program to be debugged, according to an embodiment 3.

FIG. 12 is a flow diagram illustrating an operational example of a microcomputer to be debugged, according to the embodiment 3.

### DETAILED DESCRIPTION

Descriptions will hereinafter be made to preferred embodiments by referring to the accompanying drawings. For the purpose of clarify, omission, and simplification may appropriately be made in the following explanations and illustrations. In each illustration, the same reference numerals are given to the same elements, and their description is not made over and over.

### Embodiment 1

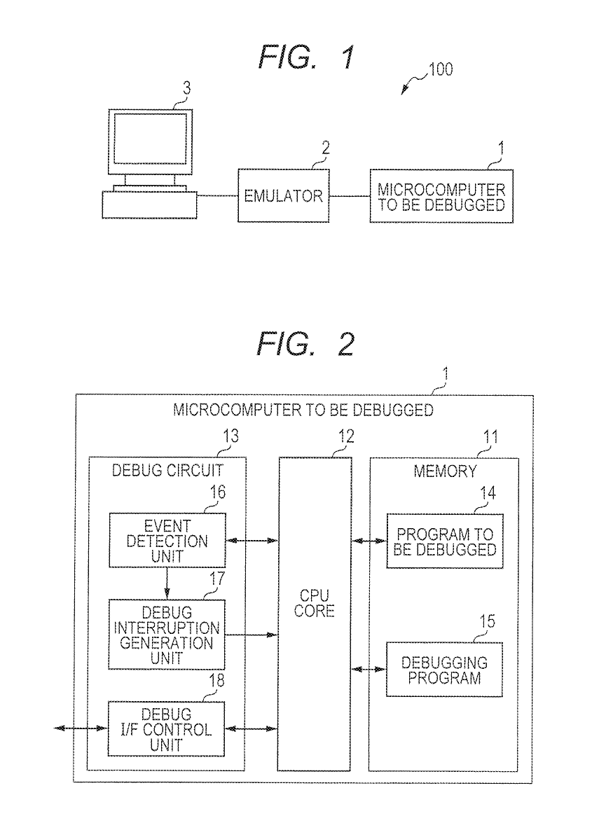

FIG. 1 is a block diagram illustrating a configuration example of a debug system 100 according to an embodiment 1. The debug system 100 includes a microcomputer 1 to be debugged, an emulator 2, and a host machine 3. The microcomputer 1 to be debugged and the emulator 2 are coupled through, for example, a flat cable. The emulator 2 and the host machine 3 are coupled through, for example, a USB (Universal Serial Bus) cable.

Descriptions will now be made to a configuration of the microcomputer 1 to be debugged, using a block diagram of FIG. 2. FIG. 2 is the block diagram illustrating a configuration example of the microcomputer 1 to be debugged of FIG. 1. The microcomputer 1 to be debugged includes a memory 11, a CPU core 12, and a debug circuit 13.

The memory 11 stores a program 14 to be debugged and a debugging program 15. The program 14 to be debugged is a user program to be debugged. The debugging program 15 is a program for measuring, for example, the establishment timing of the event in the program 14 to be debugged, its establishment interval, and the number of establishment. In the example of FIG. 2, the program 14 to be debugged and the debugging program 15 are stored in one memory 11, but may possibly be stored in separate memories.

The CPU core 12 is a processing unit which can execute a predetermined program. The CPU core 12 executes the program 14 to be debugged or the debugging program 15. The CPU core 12 is also called a CPU, an MPU (Micro Processing Unit), a microprocessor, or a processor core.

The debug circuit 13 is used when the event detection function or debugging of the program 14 to be debugged is executed. The debug circuit 13 includes an event detection unit 16, a debug interruption generation unit 17, and a debug interface control unit (a debug I/F control unit) 18.

The event detection unit 16 is a function unit for detecting establishment of an event in the program 14 to be debugged which is in execution by the CPU core 12. In this case, the event is to include a specified address in the program 14 to be debugged. In the event detection unit 16, an event number of an event to be detected whether it is established is set. The setting of the event number in this event detection unit 16 can be performed by the host machine 3 through the emulator 2. If the event of the set event number is established, the event detection unit 16 outputs event establishment information representing establishment of the event to the debug interruption generation unit 17.

The debug interruption generation unit 17 is a function unit for transiting the program to be executed by the CPU core 12 from the program 14 to be debugged to the debugging program 15 by generating debug interruption, when the event in the program 14 to be debugged has been established. The debug interruption generation unit 17 generates a debug interruption signal, when it receives event establishment information from the event detection unit 16. The debug interruption generation unit 17 outputs the generated debug interruption signal to the CPU 12.

Upon reception of the debug interruption signal from the debug interruption generation unit 17, the CPU 12 stops execution of the program 14 to be debugged, and starts execution of the debugging program 15.

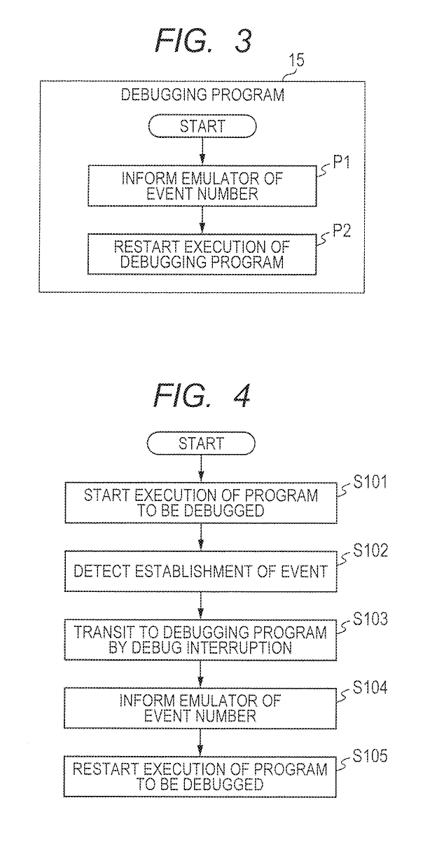

Descriptions will now be made to the debugging program 15 using FIG. 3. The debugging program 15 includes a command P1 for informing the emulator 2 of an event number and a command P2 for restarting execution of the program 14 to be debugged. In the debugging program 15, the event number to be informed to the emulator 2 is written in advance.

Descriptions will be continued with reference back to FIG. 2. The CPU core 12 executes the debugging program 15, thereby outputting the event number of an established event to the debug interface control unit 18. The CPU core 12 outputs the event number to the debug interface control unit 18, right after the execution of the debugging program 15 has started. The CPU core 12 restarts execution of the program 14 to be debugged, right after the event number has been output to the debug interface control unit 18.

The debug interface control unit 18 is a communication circuit unit which performs communication with the emulator 2. Upon reception of the event number from the CPU core 12, the debug interface control unit 18 informs the emulator 2 of the event number.

In the microcomputer 1 to be debugged in FIG. 2, with the above-described configuration, it is possible to shorten the stop time of the program to be debugged in the event detection function. This is because communication between the microcomputer 1 to be debugged and the emulator 2 includes informing only once from the debug interface control unit 18 to the emulator 2, during a period since the program 14 to be debugged is stopped until the execution is restarted. As a result, the time since the stop of the program 14 to be debugged until the restart of the execution may be several μsec.

In the above, the descriptions have been made to the example in which the event number to be informed to the emulator 2 is described in the debugging program 15. However, it is not limited to this example. The event number to be informed to the emulator 2 may be output from the event detection unit 16 to the CPU core 12, through the debug interruption generation unit 17, or without through the debug interruption generation unit 17. In this case, the CPU core 12 executes the debugging program 15, thereby outputting the event number received from the event detection unit 16 to the debug interface control unit 18.

Subsequently, descriptions will now be made to an operational example of the microcomputer to be debugged according to the embodiment 1, using the flow diagram of FIG. 4.

The CPU 12 starts execution of the program 14 to be debugged (Step S101). Then, the event detection unit 16 detects establishment of the event in the program 14 to be debugged (Step S102).

The debug interruption generation unit 17 transits the program to be executed by the CPU core 12 to the debugging program 15, by debug interruption (Step S103).

Then, the CPU core 12 informs the emulator 2 of the event number of the established event through the debug interface control unit 18 (Step S104).

The CPU core 12 restarts execution of the program 14 to be debugged, right after Step S104 (Step S105).

As described above, in the configuration of the microcomputer 1 to be debugged according to the embodiment 1, the CPU core 12 executes the debugging program 15, thereby informing the emulator 2 of the event number of the established event through the debug interface control unit 18. Right after this, it restarts the execution of the program 14 to be debugged. By this configuration, in the microcomputer 1 to be debugged according to the embodiment 1, the debug circuit 13 does not need to include the event function unit, the time measurement function unit, and the DMA controller. In the microcomputer 1 to be debugged, the timer or the DMA controller in the microcomputer 1 is not occupied for the event detection function. Further, in the microcomputer 1 to be debugged, communication between the microcomputer 1 to be debugged and the emulator 2 includes informing only once from the debug interface control unit 18 to the emulator 2, during a period since the program 14 to be debugged until the execution is restarted. That is, in the microcomputer 1 to be debugged, it is possible to shorten the stop time of the program to be debugged in the event detection function, without increasing the chip area and occupying the resource in the microcomputer.

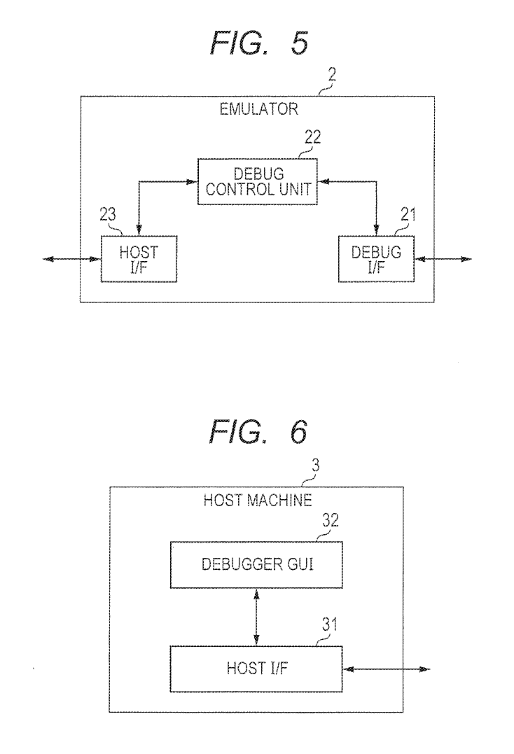

Descriptions will now be made to the emulator 2, using the block diagram of FIG. 5. FIG. 5 is a block diagram illustrating a configuration example of the emulator 2 of FIG. 1. The emulator 2 is an on-chip debug emulator. The emulator 2 includes a debug interface (debug I/F) 21, a debug control unit 22, and a host interface (host I/F) 23.

The debug interface 21 is a communication circuit unit which performs communication with the debug interface control unit 18. The debug interface 21 receives the event number of the established event from the debug interface control unit 18. The debug interface 21 outputs the received event number to the debug control unit 22.

Upon reception of the event number from the debug interface 21, the debug control unit 22 detects establishment of the event, and measures event establishment information of the event. In this case, the event establishment information represents, for example, the timing at which the event number has been received. The debug control unit 22 measures the timing at which the event number has been received as the event establishment information, using the timer inside the emulator 2. The debug control unit 22 outputs the event establishment information to the host interface 23.

The host interface 23 is a communication control unit which performs communication with the host machine 3. The host interface 23 transmits the event establishment information received from the debug control unit 22 to the host machine 3.

As described above, in the configuration of the emulator 2 according to the embodiment 1, upon reception of the event number, the debug control unit 22 detects establishment of the event, and measures the event establishment information. In the configuration, the host interface 23 transmits the event establishment information received from the debug control unit 22 to the host machine 3. Thus, the emulator 2 according to the embodiment 1 can measure the event establishment information of the established event, and transmit the event establishment information to the host machine 3.

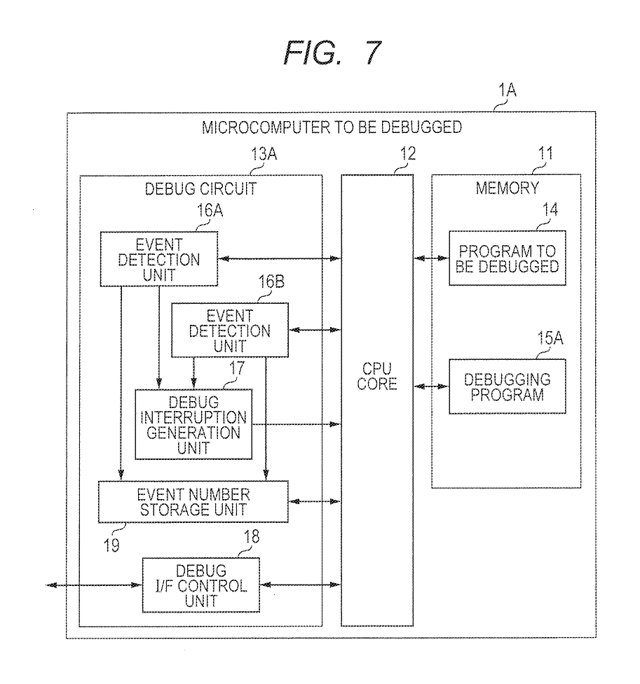

Subsequently, descriptions will now be made to the host machine 3 using the block diagram of FIG. 6. FIG. 6 is a block diagram illustrating a configuration example of the host machine 3 of FIG. 1. The host machine 3 is, for example, a general personal computer. The host machine 3 includes a host interface (host I/F) 31 and a debugger GUI 32.

The host interface 31 receives the event establishment information from the host interface 23. The host interface 31 outputs the received event establishment information to the debugger GUI 32.

The debugger GUI 32 displays the received event establishment information on the display of the host machine 3. As a result, the debugger GUI 32 can inform the user of the event establishment information. That is, the user can know the establishment timing of the event and the establishment interval of the event.

The user can start first execution (not restart execution) of the program 14 to be debugged, perform a debug operation of the program 14 to be debugged, and set the event number of the event detection unit 16, using the debugger GUI 32.

As described above, the debug system 100 according to the embodiment 1 is configured to include the above-described microcomputer 1 to be debugged and the emulator 2. As a result, it is possible to provide the debug system including the microcomputer to be debugged, with a shortened stop time of the program to be debugged in the event detection function, without increasing the chip area and occupying the resource in the microcomputer. In the debug system 100, the event establishment information of the established event is measured by the emulator 2, and the event establishment information can be transmitted to the host machine 3.

### Embodiment 2

Now, descriptions will be made to an embodiment 2. The embodiment 2 relates to a debug system 200 for detecting various kinds of events. The debug system 200 includes a microcomputer 1A, an emulator 2A, and a host machine 3. The configuration of the debug system 200 is the same as the debug system 100 according to the embodiment 1, and thus will not be described over and over.

FIG. 7 is a block diagram illustrating a configuration example of the microcomputer 1A according to the embodiment 2. The microcomputer 1A includes a memory 11, a CPU core 12, and a debug circuit 13A.

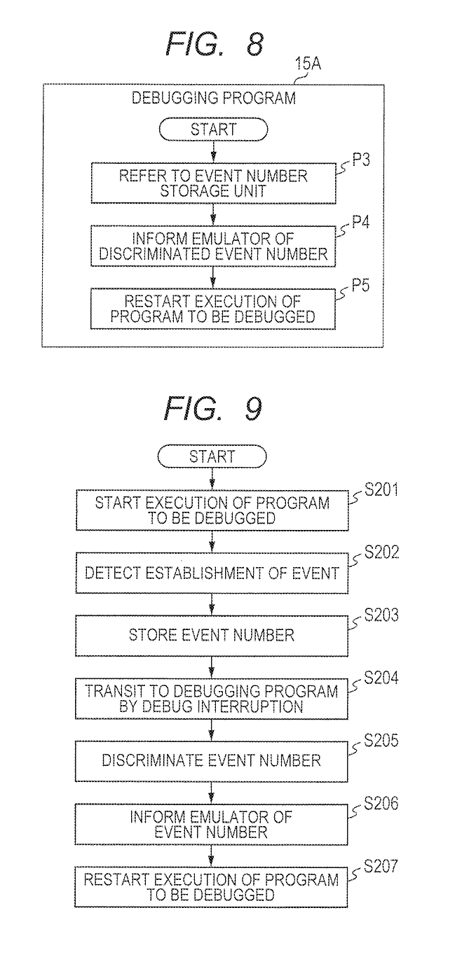

The memory 11 stores a program 14 to be debugged and a debugging program 15A. Descriptions will now be made to the debugging program 15A, using FIG. 8. The debugging program 15A includes a command P3 for referring to an event number storage unit 19, a command P4 for informing the emulator 2A of a discriminated event number, and a command P5 for restarting execution of the program 14 to be debugged. The CPU core 12 executes the command P3, thereby discriminating an event number of an established event.

Descriptions will be continued referring back to FIG. 7. The debug circuit 13A includes an event detection unit 16A, an event detection unit 16B, a debug interruption generation unit 17, a debug interface control unit 18, and an event number storage unit 19. In FIG. 7, descriptions will be made to an example, in which the microcomputer 1A includes the event detection unit 16A and the event detection unit 16B. In this case, the number of event detection units is not limited to two, and the number of detection units included in the microcomputer 1A may be any number, as long as it is equal to or greater than two.

The event detection unit 16A and the event detection unit 16B are provided to detect different events. That is, in the event detection units 16A and 16B, different event numbers are set. Descriptions will now be made to a case in which an event detected by the event detection unit 16A is assumed as an event A, while an event detected by the event detection unit 16B is assumed as an event B.

The event detection unit 16A and the event detection unit 16B store event numbers of established different events in the event number storage unit 19. That is, upon detection of events of the event numbers set therein, the event detection unit 16A and the event detection unit 16B output the event numbers to the event number storage unit 19. Upon detection of the events of the event numbers set therein, the event detection unit 16A and the event detection unit 16B output event establishment information representing establishment of the events to the debug interruption generation unit 17.

The event number storage unit 19 stores event numbers. Upon reception of the event numbers from the event detection unit 16A and the event detection unit 16B, the event number storage unit 19 stores the received event numbers.

Upon reception of a debug interruption signal from the debug interruption generation unit 17, the CPU core 12 stops execution of the program 14 to be debugged, and starts execution of the debugging program 15A.

By executing the debugging program 15A, the CPU core 12 discriminates the event number of the established event, by referring to the event number storage unit 19. The CPU core 12 outputs the discriminated event number to the debug interface control unit 18. Further, after the CPU core 12 outputs the event number to the debug interface control unit 18, it restarts execution of the program 14 to be debugged.

Descriptions will now be made to an operational example of the microcomputer 1A to be debugged according to the embodiment 2, using the flow diagram of FIG. 9.

The CPU core 12 starts execution of the program 14 to be debugged (Step S201). The event detection unit 16A and the event detection unit 16B detect establishment of the event A or the event B in the program 14 to be debugged (Step S202).

The event number storage unit 19 stores the even number of the established event A or B (Step S203).

The debug interruption generation unit 17 transits the program executed by the CPU core 12 to the debugging program 15A, by debug interruption (Step S204).

The CPU core 12 discriminates the event number of the established event A or B, by referring to the event number storage unit 19 (Step S205).

The CPU core 12 informs the emulator 2A of the event number of the established event A or B through the debug interface control unit 18 (Step S206).

Right after Step S206, the CPU core 12 restarts execution of the program 14 to be debugged (Step S207).

Descriptions will now be made to the emulator 2A according to the embodiment 2. The configuration of the emulator 2A is the same as the configuration of the emulator 2 according to the embodiment 1, and thus will not be described over and over. The emulator 2A includes a debug interface 21, a debug control unit 22A, and a host interface 23.

Upon reception of the event number from the debug interface 21, the debug control unit 22A detects establishment of the event, and measures event establishment information. That is, when the debug control unit 22A receives the event number of the event A, it measures the event establishment information of the event A. When it receives the event number of the event B, it measures the event establishment information of the event B.

The debug control unit 22A measures event generation interval information representing a generation interval of events of different event numbers, using the timer in the emulator 2A. For example, when the debug control unit 22A receives the event number of the event A, and then receives the event number of the event B, it measures a time internal of the timing of receiving the event number of the event A and the timing of receiving the event number of the event B, as the event generation interval information.

The debug control unit 22A transmits the event establishment information or the event generation interval information to the host machine 3 through the host interface 23.

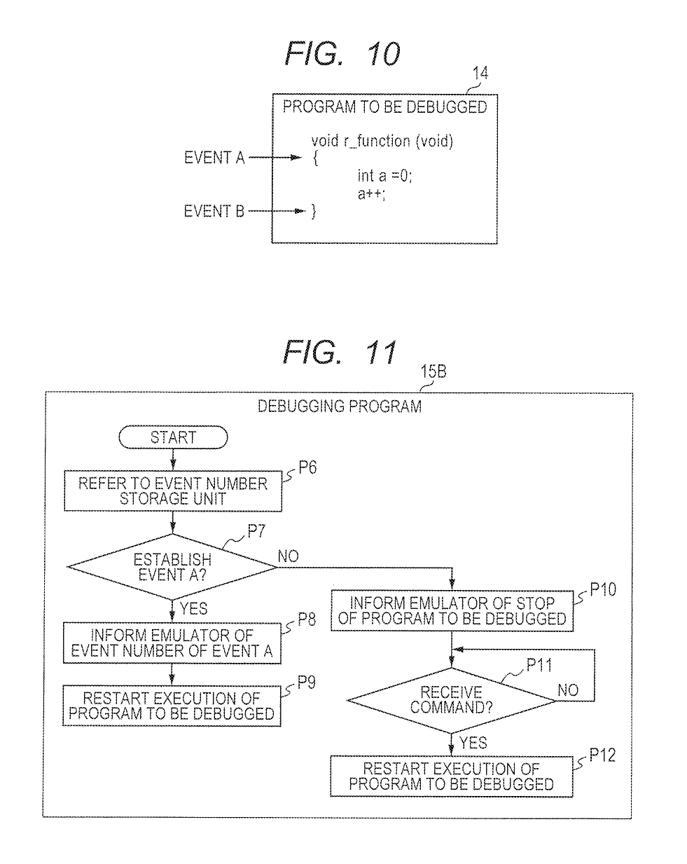

FIG. 10 is a diagram illustrating an example of an event in the program 14 to be debugged according to the embodiment 2. In the example of FIG. 10, a symbol “{” as a start address of a function is set as an event A, while another symbol “}” as an end address of the function is set as an event B. In this case, in the debug control unit 22A, it is possible to measure the execution time of the function as the event generation interval information. If the same event is continuously detected, for example, if the event A is continuously detected, it is possible to inform the user that a critical bug is generated.

Accordingly, the microcomputer 1A according to the embodiment 2 is configured to include a plurality of event detection units and also the event number storage unit 19 storing an event number. In the microcomputer 1A, the plurality of event detection units are configured to store the event number of the established event in the event number storage unit 19. Further, in the microcomputer 1A, the CPU core 12 is configured to execute the debugging program 15A, thereby discriminating the event number of the established event, by referring to the event number storage unit 19. As a result, in the microcomputer 1A, it is possible to detect establishment of various kinds of events, and to inform the emulator 2A of the event number of the established events.

In the debug system 200, the emulator 2A is configured to measure the generation interval of events of different event numbers. As a result, in the debug system 200, the emulator 2A can transmit the event generation interval information to the host machine 3.

### Embodiment 3

Descriptions will now be made to an embodiment 3. The embodiment 3 relates to a debug system 300 which can appropriately use the function described in the embodiment 1 and a function for informing that the program to be debugged described in the background is stopped. The debug system 300 includes a microcomputer 1B, an emulator 2B, and a host machine 3. The configuration of the debug system 300 is the same as that of the debug system 100 according to the embodiment 1, and thus will not be described over and over.

Descriptions will now be made to the microcomputer 1B. The configuration of the microcomputer 1B is the same as the configuration of the microcomputer 1A according to the embodiment 2, and thus will not be described over and over. The microcomputer 1B includes a memory 11, a CPU core 12, and a debug circuit 13A. The memory 11 stores a program 14 to be debugged and a debugging program 15B. That is, the microcomputer 1B has the same configuration as that of the microcomputer 1A according to the embodiment 2, except that the contents of the debugging program 15B are different from the contents of the debugging program 15A.

Descriptions will now be made to a case, in which the event A detected by the event detection unit 16A is an event for the function described in the embodiment 1, and the event B detected by the event detection unit 16B is an event for the function for informing that the program to be debugged described in the background is stopped.

FIG. 11 is a diagram illustrating an example of the debugging program 15B according to the embodiment 3. The debugging program 15B includes commands P6 to P12. The command P6 is a command for referring to the event number storage unit 19. The CPU core 12 executes this command P6, thereby discriminating the event number of an established event.

The commands P7 to P12 are commands for executing either of two different controls in accordance with the event number of the established event. The command P7 is for classifying the established event into the event A or the event B.

The commands P8 and P9 are commands in a case where the established event is the event A. Specifically, the command P8 is for informing the emulator 2B of the event number of the event A, while the command P9 is for restarting execution of the program 14 to be debugged.

The commands P10 to P12 are commands in a case where the established event is the event B. Specifically, the command P10 is for informing the emulator 2B of a stop signal representing that the program 14 to be debugged is to be stopped, while the command P11 is for determining whether a debug control request command has been received from the emulator 2B. The command P12 is for restarting execution of the program 14 to be debugged. The command P12 is for executing the command in a case where the debug control request command has been received by the command P11.

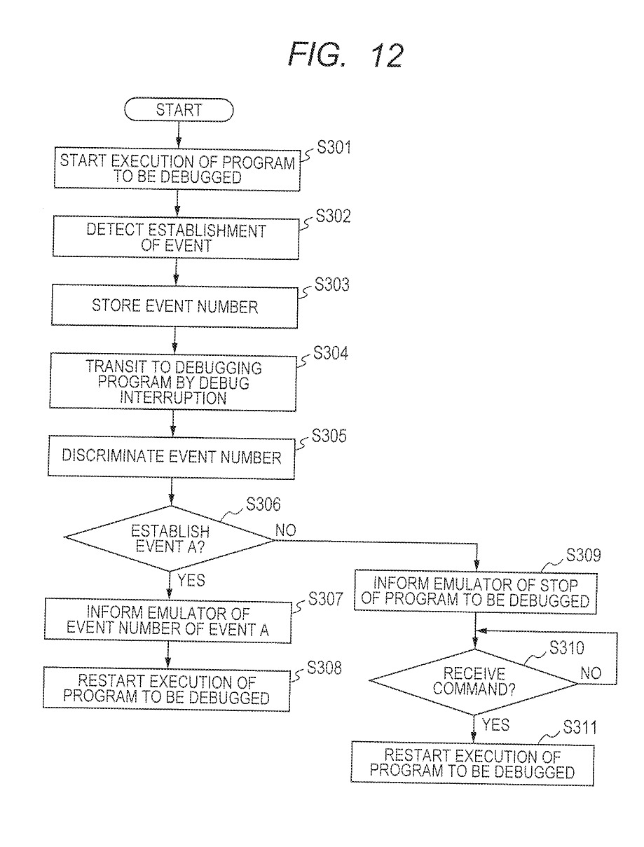

Now, descriptions will now be made to an operational example of the microcomputer 1B to be debugged according to the embodiment 3, using the flow diagram of FIG. 12.

Operations of Step S301 to S305 are the same as those from Step S201 to S205 of the microcomputer 1A to be debugged according to the embodiment 2, and thus will not be described over and over.

The CPU core 12 determines whether the established event is the event A (Step S306). That is, the CPU 12 determines whether the event number discriminated in Step S305 is the event number of the event A.

When the established event is the event A (YES in S306), the CPU core 12 informs the emulator 2B of the event number of the established event A through the debug interface control unit 18 (Step S307).

Right after Step S307, the CPU core 12 restarts execution of the program 14 to be debugged (Step S308).

When the established event is the event B (NO in Step S306), the CPU core 12 informs the emulator 2B of a stop signal representing that the program to be debugged is to be stopped through the debug interface control unit 18 (Step S309).

After Step S309, the CPU core 12 waits for a debug control request from the emulator 2B (Step S310).

When the debug control request command has been received (YES in S310), the CPU core 12 restarts execution of the program 14 to be debugged (Step S311).

Descriptions will now be made to the emulator 2B according to the embodiment 3. The configuration of the emulator 2B is the same as the configuration of the emulator 2 according to the embodiment 1, and thus will not be described over and over. The emulator 2B includes a debug interface 21, a debug control unit 22B, and a host interface 23.

The debug interface 21 outputs a signal received from the debug interface control unit 18 to the debug control unit 22B. That is, when the event number is received, the debug interface 21 outputs the event number to the debug control unit 22B. When the stop signal is received, it outputs the stop signal to the debug control unit 22B.

When a debug control request command is received from the debug control unit 22B, the debug interface 21 transmits the debug control request command to the debug interface control unit 18.

When the event number is received from the debug interface 21, the debug control unit 22B detects establishment of the event, and measures event establishment information. The debug control unit 22 outputs the event establishment information to the host interface 23.

Upon reception of a stop signal from the debug interface 21, the debug control unit 22B detects stop of the program to be debugged. The debug control unit 22B outputs the received stop signal to the host interface 23.

Upon reception of a debug control request command from the host interface 23, the debug control unit 22B outputs the debug control request command to the debug interface 21.

The host interface 23 transmits the signal received from the debug control unit 22B to the host machine 3. That is, upon reception of the event establishment information, the host interface 23 transmits the event establishment information to the host machine 3. Upon reception of the stop signal, it transmits the stop signal to the host machine 3.

Upon reception of the debug control request command from the host machine 3, the host interface 23 outputs the debug control request command to the debug control unit 22B.

As described above, the microcomputer 1B according to the embodiment 3, the CPU core 12 is configured to execute the debugging program 15B, thereby executing either of two different controls in accordance with the event number of the established event. Either of the two different controls is to restart execution of the program 14 to be debugged, right after informing the emulator 2B of the event number of the established event, through the debug interface control unit 18. The other of the two different controls is to inform the emulator 2B of stop of the program 14 to be debugged, through the debug interface control unit 18. As a result, in the microcomputer 1B, it is possible to appropriately use the function for informing the event number as described in the embodiment 1 and the function for informing the stop of the program to be debugged as described in the background.

In the above descriptions, the embodiment 3 is to operate appropriate use of the function described in the embodiment 1 and the function for informing the stop of the program to be debugged as described in the background. However, it is not limited to this example. The embodiment 3 may be to operate appropriate use of the function described in the embodiment 2 and the function for informing the stop of the program to be debugged as described in the background.

The debugging program described in the embodiments 1 to 3 is stored using various types of non-transitory computer readable mediums, and then can be supplied to a computer. The non-transitory computer readable medium includes various types of tangible storage mediums. Examples of the non-transitory computer readable mediums include a magnetic recording medium (for example, a flexible disc, a magnetic tape, a hard disc drive), an optical magnetic recording medium (for example, an optical magnetic disc), a CD-ROM (Read Only Memory) CD-R, CD-R/W, a semiconductor memory (for example, a mask ROM, a PROM (Programmable ROM)), an EPROM (Erasable PROM), a flash ROM, and a RAM (Random Access Memory). The debugging program may be supplied to a computer through various types of transitory computer readable mediums. Examples of the transitory computer readable mediums include an electric signal, an optical signal, and an electromagnetic wave. The transitory computer readable mediums are used for supplying the debugging program to the computer, through a wired communication path (an electric cable or an optical fiber) or a wireless communication path.

Accordingly, the descriptions have specifically been made to the inventions made by the present inventors based on the embodiments. However, the present invention is not limited to the above-described embodiments.

Various changes may possibly be made without departing from the scope thereof.

The preferred embodiments may partially or entirely be described as follows, but are not limited thereto.

### [Additional Note 1]

A microcomputer comprising:

a CPU (Central Processing Unit) core which can execute a predetermined program;

a memory which stores a program to be debugged and a debugging program;

an event detection unit which detects establishment of an event in the program to be debugged which is being executed by the CPU core;

a debug interruption generation unit which transits a program to be executed by the CPU core from the program to be debugged to the debugging program, by generating debug interruption, when the event is established; and

a debug interface control unit which performs communication with an emulator, and

wherein the CPU core executes the debugging program, thereby informing the emulator of an event number of the established event through the debug interface control unit, and right thereafter restarting execution of the program to be debugged.

### [Additional Note 2]

The microcomputer according to the additional note 1, further comprising:

the event detection unit includes a plurality of event detection units; and

an event number storage unit which stores the event number,

wherein each of the event detection units stores the event number of the established event in the event number storage unit, and

wherein the CPU core executes the debugging program, thereby discriminating the event number of the established event by referring to the event number storage unit.

### [Additional Note 3]

The microcomputer according to the additional note 2,

wherein the CPU core executes the debugging program, thereby discriminating the event number of the established event, thereafter executing either of two different controls in accordance with the event number.

### [Additional Note 4]

The microcomputer according to the additional note 3,

wherein one of the different controls is to inform the emulator of the event number of the established event through the debug interface control unit, and right thereafter to restart execution of the program to be debugged, and

wherein other of the different controls is to inform the emulator of stop of the program to be debugged through the debug interface control unit.

### [Additional Note 5]

A debug system comprising:

a microcomputer; and

an emulator,

wherein the microcomputer includes
a CPU (Central Processing Unit) core which can execute a predetermined program,
a memory which stores a program to be debugged and a debugging program,
an event detection unit which detects establishment of an event in the program to be debugged which is being executed by the CPU core,
a debug interruption generation unit which transits a program to be executed by the CPU core from the program to be debugged to the debugging program, by generating debug interruption, when the event is established, and
a debug interface control unit which performs communication with the emulator,

wherein the emulator includes
a debug interface which performs communication with the debug interface control unit,
a debug control unit which detects an event of an event number which is received by the debug interface, and measures event establishment information of the event, and
a host interface which performs communication with a host machine,

wherein the CPU core executes the debugging program, thereby informing the emulator of the event number of the established event through the debug interface control unit, and right thereafter restarting execution of the program to be debugged, and

wherein the host interface transmits the event establishment information to the host machine.

### [Additional Note 6]

The debug system according to the additional note 5,

wherein the microcomputer further includes
a plurality of event detection units, and
an event number storage unit which stores the event number,

wherein each of the event detection units stores the event number of the established event in the event number storage unit, and

wherein the CPU core executes the debugging program, thereby discriminating the event number of the established event by referring to the event number storage unit.

### [Additional Note 7]

The debug system according to the additional note 6,

wherein the debug control unit further measures a generation interval between events of different event numbers.

### [Additional Note 8]

The debug system according to the additional note 7,

wherein the CPU core executes the debugging program, thereby discriminating the event number of the established event, thereafter executing either of two different controls in accordance with the event number.

### [Additional Note 9]

The debug system according to the additional note 8,

wherein one of the different controls is to inform the emulator of the event number of the established event through the debug interface control unit, and right thereafter to restart execution of the program to be debugged, and

wherein other of the different controls includes informing the emulator of stop of the program to be debugged through the debug interface control unit.

### [Additional Note 10]

A method for a microcomputer, comprising the steps of:

detecting establishment of an event in a program to be debugged which is being executed by a CPU core; and

transiting a program to be executed by the CPU core from the program to be debugged to a debugging program, when the event is established;

wherein the CPU core executes the debugging program, thereby informing an emulator of an event number of an established event, and right thereafter restarting execution of the program to be debugged.

### [Additional Note 11]

The method according to the additional note 10, further comprising the step of

storing the event number of the established event, when the event is established, and

wherein the CPU core executes the debugging program, thereby discriminating the event number of the established event by referring to the stored event number.

### [Additional Note 12]

12. The method according to the additional note 11,

wherein the CPU core executes the debugging program, thereby discriminating the event number of the established event, thereafter executing either of two different controls in accordance with the event number.

### [Additional Note 13]

The method according to the additional note 12,

wherein one of the different controls is to inform the emulator of the event number of the established event, and right thereafter to restart execution of the program to be debugged, and

wherein other of the different controls includes informing the emulator of stop of the program to be debugged.

### [Additional Note 14]

A monitor program which starts execution, when an event in a program to be debugged is established, the program controlling a computer to execute:

informing an emulator of an event number of the established event; and

restarting execution of the program to be debugged, right after the informing.

### [Additional Note 15]

The monitor program according to the additional note 14, for further controlling a computer to execute

discriminating the event number of an established event by referring to an event number storage unit which stores the event number of the established even, when the event is established.

### [Additional Note 16]

The monitor program according to the additional note 15, for further controlling a computer to execute

executing either of two different controls in accordance with the event number, after discriminating the event number of the established event.

### [Additional Note 17]

The monitor program according to the additional note 16,

wherein one of the different controls is to inform the emulator of the event number of the established event, and right thereafter to restart execution of the program to be debugged, and

wherein other of the different controls includes informing the emulator of stop of the program to be debugged.

What is claimed is:

1. A microcomputer comprising:
a CPU (Central Processing Unit) core which can execute a predetermined program;
a memory which stores a program to be debugged and a debugging program;
an event detection unit which detects establishment of an event in the program to be debugged which is being executed by the CPU core;
a debug interruption generation unit which transits a program to be executed by the CPU core from the program to be debugged to the debugging program, by generating debug interruption, when the event is established; and
a debug interface control unit which performs communication with an emulator, and
wherein the CPU core executes the debugging program, thereby informing the emulator of an event number of the established event through the debug interface control unit, and right thereafter restarting execution of the program to be debugged.

2. The microcomputer according to claim 1, further comprising:
the event detection unit includes a plurality of event detection units; and
an event number storage unit which stores the event number,
wherein each of the event detection units stores the event number of the established event in the event number storage unit, and
wherein the CPU core executes the debugging program, thereby discriminating the event number of the established event by referring to the event number storage unit.

3. The microcomputer according to claim 2,
wherein the CPU core executes the debugging program, thereby discriminating the event number of the established event, thereafter executing either of two different controls in accordance with the event number.

4. The microcomputer according to claim 3,
wherein one of the different controls is to inform the emulator of the event number of the established event through the debug interface control unit, and right thereafter to restart execution of the program to be debugged, and
wherein other of the different controls is to inform the emulator of stop of the program to be debugged through the debug interface control unit.

5. A debug system comprising:
a microcomputer; and
an emulator,
wherein the microcomputer includes
a CPU (Central Processing Unit) core which can execute a predetermined program,
a memory which stores a program to be debugged and a debugging program,
an event detection unit which detects establishment of an event in the program to be debugged which is being executed by the CPU core,
a debug interruption generation unit which transits a program to be executed by the CPU core from the program to be debugged to the debugging program, by generating debug interruption, when the event is established, and
a debug interface control unit which performs communication with the emulator,
wherein the emulator includes
a debug interface which performs communication with the debug interface control unit,
a debug control unit which detects an event of an event number which is received by the debug interface, and measures event establishment information of the event, and
a host interface which performs communication with a host machine,
wherein the CPU core executes the debugging program, thereby informing the emulator of the event number of the established event through the debug interface control unit, and right thereafter restarting execution of the program to be debugged, and
wherein the host interface transmits the event establishment information to the host machine.

6. The debug system according to claim 5,
wherein the microcomputer further includes
a plurality of event detection units, and
an event number storage unit which stores the event number,
wherein each of the event detection units stores the event number of the established event in the event number storage unit, and
wherein the CPU core executes the debugging program, thereby discriminating the event number of the established event by referring to the event number storage unit.

7. The debug system according to claim 6,
wherein the debug control unit further measures a generation interval between events of different event numbers.

8. The debug system according to claim 6,
wherein the CPU core executes the debugging program, thereby discriminating the event number of the established event, thereafter executing either of two different controls in accordance with the event number.

9. The debug system according to claim 8,
wherein one of the different controls is to inform the emulator of the event number of the established event through the debug interface control unit, and right thereafter to restart execution of the program to be debugged, and
wherein other of the different controls includes informing the emulator of stop of the program to be debugged through the debug interface control unit.

10. A method for a microcomputer, comprising the steps of:
detecting establishment of an event in a program to be debugged which is being executed by a CPU core; and
transiting a program to be executed by the CPU core from the program to be debugged to a debugging program, when the event is established;
wherein the CPU core executes the debugging program, thereby informing an emulator of an event number of an established event, and right thereafter restarting execution of the program to be debugged.

11. The method according to claim 10, further comprising the step of
storing the event number of the established event, when the event is established, and
wherein the CPU core executes the debugging program, thereby discriminating the event number of the established event by referring to the stored event number.

12. The method according to claim 11,
wherein the CPU core executes the debugging program, thereby discriminating the event number of the established event, thereafter executing either of two different controls in accordance with the event number.

13. The method according to claim 12,
wherein one of the different controls is to inform the emulator of the event number of the established event, and right thereafter to restart execution of the program to be debugged, and
wherein other of the different controls includes informing the emulator of stop of the program to be debugged.
